(19) United States
(12) Patent Application Publication
(10) Pub. No.: US 2011/0286120 A1
(43) Pub. Date: Nov. 24, 2011

(54) OPTICAL LENS SNAP ATTACHMENT

(76) Inventor: William F. Harris, Charlotte, NC (US)

(21) Appl. No.: 12/854,794

(22) Filed: Aug. 11, 2010

Related U.S. Application Data
(60) Provisional application No. 61/345,989, filed on May 18, 2010.

(51) Int. Cl. G02B 7/02

(52) U.S. Cl. 359/827

(57) ABSTRACT

An optical apparatus is provided that directs, diffuses, magnifies or otherwise alters light. The optical apparatus may include a lens that can be physically attached to a circuit board without glue, adhesive tape, or melting. The optical apparatus can be snapped onto the circuit board. The optical apparatus may then be glued or otherwise adhered to the circuit board after being snapped on.

### CROSS-REFERENCE TO RELATED APPLICATION

This patent application claims priority to U.S. Provisional Patent Application No. 61/345,989, filed May 18, 2010, titled “OPTICAL LENS SNAP ATTACHMENT,” which is hereby incorporated by reference in its entirety.

### FIELD

Embodiments of the present invention relate to optical apparatuses, systems, methods and other means for directing, diffusing, magnifying and/or otherwise altering light and, more particularly, a lens that is configured to be physically attached to a circuit board in proximity to one or more light emitting devices.

### BACKGROUND

Light emitting diodes (“LEDs”) are becoming an alternative to traditional light bulbs, because LEDs are relatively smaller and more efficient devices. LEDs are often made from semiconductor materials, which emit light in response to receiving electrical current. A LED is often mounted onto a circuit board that can include circuitry, memory and/or other components configured to drive each LED by controlling the flow of electricity supplied to each LED.

Relative to traditional light bulbs, LEDs consume less power and often last longer. Moreover, relatively recent innovation has improved the brightness of light emitted by LEDs. LEDs can also be combined or otherwise configured to emit various colors of visible light as well as various wavelengths of nonvisible light (e.g., ultra-violet light, infrared light, etc.). As a result, LEDs are being used for a wide range of applications, including traffic lights, handheld flash lights, automobile lights, architectural lighting, display screens, and camera flashes, just to name a few.

One or more LEDs can be integrated into something referred to herein as a “package”, which allows LEDs to be more easily handled. An LED package often includes an LED casing having two electrical contacts, typically anode and cathode wire leads, extending therefrom. The LED die, which includes the light emitting circuit, can be enclosed and protected by the LED casing. Some LED packages also include a metal slug, in which the LED die and/or other parts of the LED package can be mounted and used to help disperse heat.

The LED casing can be formed into any shape (e.g., cylindrical, spherical, rectangular, triangular, etc.). Similarly, the LED casing can be any size, and usually range in size between 3 mm and 8 mm, with 5 mm being one of the most common. LED casings are usually at least partially translucent for at least one wavelength of light, and can also be any color or otherwise filter the light emitted from the LED die.

However, rather than or in addition to modifying a standard LED casing, an external lens or other type of optical component is sometimes used to diffuse, magnify, direct or otherwise alter the light pattern emitted from the LED package. Although such optical components provide a number of benefits, and can be adapted to particular shapes and sizes of LED packages, it would be desirable for such optical components to be further improved.

### BRIEF SUMMARY

Embodiments discussed herein are related to apparatuses, methods and other means for, among other things, snapping an optical lens onto a circuit board. For example, an optical apparatus may include the optical lens along with at least three support members.

At least one of the support members can be a mounting post, which includes a tip located at a distal end. The tip, however, can be specifically adapted (e.g., rounded, ramped, pointed, conical or otherwise tapered, including a combination thereof) to guide the distal end of mounting post into a hole in the circuit board. The mounting post can also include a contact face or other structural component, which is configured to prevent a portion of the support member from protruding through the hole in the circuit board. The portion that is prevented from protruding through the hole can be located between the tip and the optical lens. For example, the portion can be cylindrical and have a diameter larger than that of the hole in the circuit board.

At least one of the support members can also include a notch located between the tip and the optical lens. The notch can be configured to physically attach the optical apparatus to the circuit board. The notch can be formed in the outer portion of the mounting post, such that the notch faces away from an imaginary axis, wherein the imaginary axis runs orthogonal to the circuit board, parallel to the support members and through the center of the optical lens. Additionally, the notch can be configured to snap into the hole in the circuit board.

The optical apparatus can further comprise a receptacle configured to receive a light emitting component, such as an entire LED package, only an LED die, or other type of light emitting device or combination thereof. In this regard, the receptacle can be, for example, a cavity within the main body of the optical apparatus. The cavity can include an interior surface that is shaped to at least substantially trace one or more contours of the light emitting component. In some embodiments, the receptacle can be configured to receive at least two light emitting components, such as two LED packages.

The optical apparatus can also include a second support member that is configured to be an alignment post (as opposed to a mounting post). As referenced herein, an “alignment post” can be similar to a mounting post, but lacks a notch or other attaching component and instead be configured to contact a face of the circuit board to prevent a portion of the alignment post from protruding into and/or through the circuit board. The alignment post can also include an alignment tip configured to enter a second hole in the circuit board without attaching the support post to the circuit board.

In some embodiments, a plurality of support members can be included that function as a mounting post. For example, an optical apparatus may include two mounting posts, each having a notched attaching mechanism, and an alignment post having an alignment tip that does not physically attach the optical apparatus to the circuit board. As another example, one or more support members, can be included and be configured to support the optical apparatus without passing through a hole in the circuit board. In this regard, the support post(s) can include a tip that is configured to contact one face of the circuit board without entering and/or passing through a hole in the circuit board.

One or more methods for affixing the optical apparatus to a circuit board may also be implemented. While some embodiments of the optical apparatus can be configured for manual attachment to a circuit board, the attachment process can be automated as well. For example, circuitry can be configured to automatically align a support member of the optical apparatus with a hole in the circuit board. A force can then be applied to the optical apparatus manually and/or by a machine. The force may be in a direction towards the circuit board and can be sufficient to cause the support member to bend inwardly while the force is being applied. As a result of the force being applied, the support member can snap onto the circuit board after, for example, a nub of the attaching mechanism clears the bottom face of the circuit board, or otherwise passes through a portion of the circuit board. In some embodiments, circuitry can be configured to simultaneously align a number of support members with corresponding holes in the circuit board.

In addition to snapping the optical apparatus onto the circuit board, other types of attaching means can be used to further secure the optical apparatus to the circuit board. For example, an adhesive material can be applied to the support member and/or to the circuit board. As another example, a portion of the support member and/or circuit board can be melted and allowed to solidify to create a stronger bond between the support member and the circuit board.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIGS. 1, 2A and 2B show a light emitting system and a detailed view of a component thereof in accordance with some embodiments;

FIGS. 3A-3C and 4A-4D show another light emitting system and detailed views of internal and external components thereof in accordance with some embodiments;

FIGS. 5A and 5B show an optical apparatus that can be included in a light emitting system and a detailed view of a component thereof in accordance with some embodiments;

FIG. 6 shows another optical apparatus in accordance with some embodiments; and

FIG. 7 shows a process flow in accordance with some embodiments.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

LED optical apparatuses can be attached to a circuit board and/or the LED package by any means, including adhesive (e.g., double-sided tape), glue, screws, and/or melting. Each of these attaching means can be relatively time consuming and expensive, and often require industrial manufacturing systems to implement. For example, even a relatively modest project requiring the attachment of 500,000 optical components to circuit boards using at least a million small screws (two per optical component) would require the use of expensive machinery or hundreds of workers to complete in a relatively short period of time.

Some embodiments of the present invention would allow each of the optical components to be snapped onto the circuit board, thereby reducing the time and cost often associated with attaching an optical element to a lighting component, such as an LED package. (As used herein, “snapped” or “snap” refers to physically attaching one component to another as a result of pressure being applied to one or both of the components, such that one or both of the components and/or one or more portions thereof temporarily contort while the pressure is being applied, thereby causing the components to subsequently lock into place by returning to a less or non-contorted physical state. Once locked into place, the two components may be considered removably locked or irremovably locked, wherein physically separating irremovably locked components would require damaging or destructing at least one of the components, and physically separating removably locked components would not incur any permanent damage to the components.)

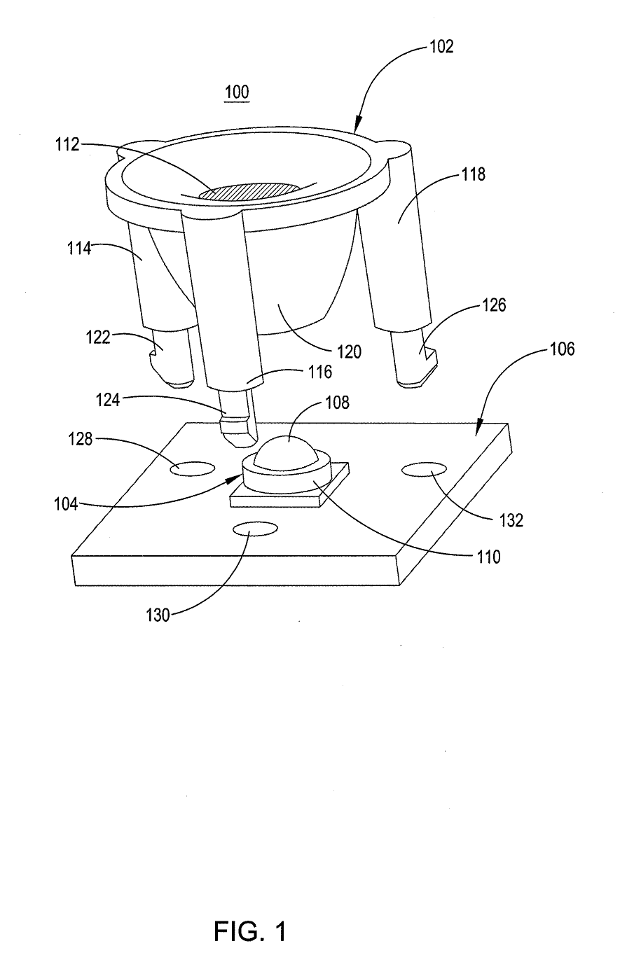

FIG. 1 shows light emitting system 100, which includes optical apparatus 102, LED package 104, and circuit board 106. LED package 104 is shown in FIG. 1 as including casing 108 and metal slug 110. LED casing 108 is shown as being cylindrical, but one skilled in the art would appreciate LED casing 108 can be any shape, irregular or regular (e.g., spherical, rectangular, triangular, etc.). Similarly, LED casing 108 can be any size, including having a diameter between 3 mm and 8 mm. LED casing 108 can be translucent in at least one wavelength of light, while being opaque in another (e.g., allowing passage of infrared light while blocking the passage of ultraviolet light). LED casing 108 can also be colored or otherwise configured to filter or alter some or all of the types of light emitted from the LED die (not shown in FIG. 1, but embedded within LED casing 108) in any other manner. LED casing 108 can be formed from plastic, glass, any other suitable material or combinations thereof. In some embodiments, LED casing 108 can be omitted from LED package 104.

Metal slug 110 can be configured to help disperse heat generated by the LED. Metal slug 110 can be comprised of any material or combination of materials. Metal slug 110 can be embedded or otherwise attached, physically and/or electrically, to circuit board 106. In some embodiments, metal slug 110 can be isolated from the cathode and/or anode leads (not shown) incorporated in LED package 104 and used to power the LED die of LED package 104. In some embodiments, metal slug 110 can be omitted from LED package 104.

Optical apparatus 102 can include lens 112 that can be, for example, any type of optical lens configured to direct, diffuse, magnify or otherwise alter light emitted from LED package 104. Lens 112 can include dimples, bends, light reflective material, light absorbent material, any other structural feature and/or material that can influence how light passes through lens 112 and/or protects LED package 104, or combination thereof. Similarly, the interior cavity or cavities of optical apparatus 102 can include one or more components, shapes, etc. that may impact how light emitted by LED package 104 emanates from optical apparatus 102. In some embodiments, lens 112 can be independently removable from optical apparatus 102. In other embodiments, lens 112 can only be removed by damaging optical apparatus 102 or by removing the entire optical apparatus 102 from circuit board 106.

Optical apparatus 102 is also shown as being configured to physically attach to circuit board 106. In this regard, optical apparatus 102 is shown in FIG. 1 as including support members 114, 116 and 118. Each of support members 114, 116 and 118 are considered for purposes of this disclosure as “mounting posts.” (As used herein, a mounting post is a support member that is configured to be physically attached to a circuit board or LED package.)

Each of support members 114, 116 and 118 can be attached to main body 120. In some embodiments one or more of support members 114, 116, and 118 can comprise the same or different materials as main body 120 and/or as each other. For example, support members may comprise aluminum and/or one or more other types of metal (due to the physical properties of the metal(s), such as flexibility and strength), whereas main body 120 can comprise one or more types of different materials, such as plastics and/or different metals. Alternatively, main body 120 and one or more of support members 114, 116, and 118 can be formed from the same type or types of material and, in some cases, the same molding or piece of material.

Each of support members 114, 116 and 118 is shown as including a mechanical attaching component, for example, notches 122, 124 and 126, respectively, that allow support members 114, 116 and 118 to mount optical apparatus 102 to circuit board 106. Notches 122, 124 and 126 would respectively enable each of optical apparatus 102's three support members 114, 116 and 118 to be snapped onto and engaged by circuit board 106 by means of holes 128, 130 and 132 respectively.

As shown in FIG. 1, holes 128, 130 and 132 could be arranged to receive support members 114, 116 and 118, such that lens 112 can alter the light emitted from LED package 104 relative to the orientation of circuit board 106. For example, lens 112 may be aligned with and centered above LED package 104 with support members 114, 116 and 118 positioned about LED package 104. Circuit board 106 can be embedded in, for example, an airport's runway and lens 112 can be configured to direct a certain color of light in a certain direction, while blocking the light's emission in all other directions (with the direction(s) being relative to how the holes are arranged in the circuit board and/or the support members 114, 116, and 118 on the main body 120). In this regard, pilots may only see the color of light emitted by light emitting system 100 when their airplanes approach from a particular direction. In addition to or instead of being configured such that lens 112 is oriented relative to the supporting members, an indentation, a printed indicator, other orientation component(s), or combination thereof can be included in optical apparatus 102, LED package 104 and/or circuit board 106 to realize proper alignment for the intended orientation.

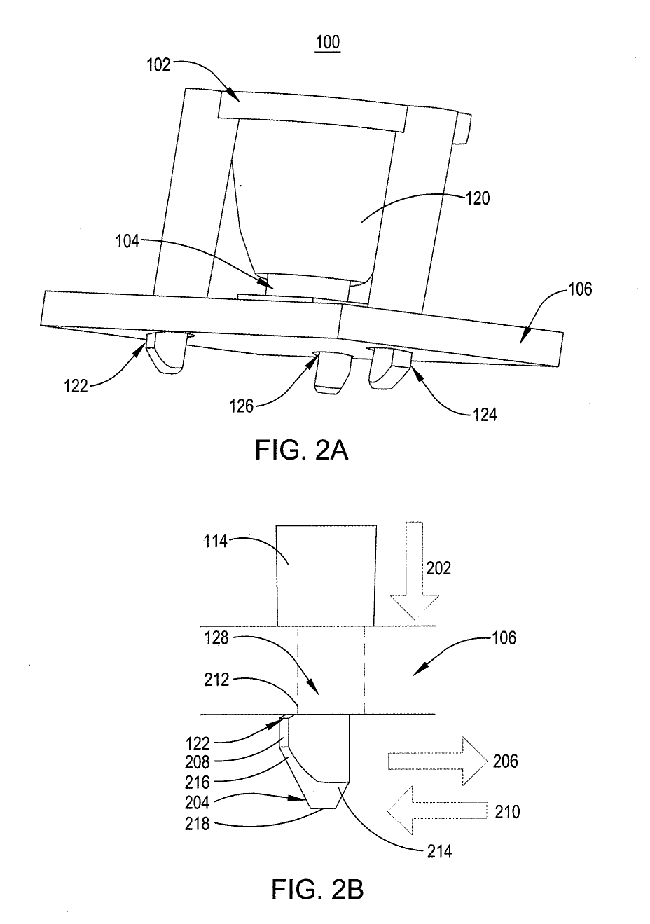

FIG. 2A shows system 100 with optical apparatus 102 physically attached to circuit board 106. FIG. 2A also shows how LED package 104, or at least a portion thereof, and a portion of metal slug 110 can be received by a cavity (some examples of which are discussed below) that is incorporated into main body 120 of optical apparatus 102.

As shown in FIGS. 2A and 2B, in response to a sufficient force being applied in the direction of arrow 202, notches 122, 124 and 126 are configured to engage circuit board 106, thereby physically attaching optical lens 102 to circuit board 106. The amount of force required in the direction of arrow 202 may be dependent on, for example, the rigidness, thickness, shape, and other characteristics of support member 114 and/or circuit board 128. As notch 122 passes through hole 128 (which may be configured to receive tapered tip 204 as shown in FIG. 2B), support member 114 may temporarily bend or otherwise contort, causing tapered tip 204 to move in the direction of arrow 206. Tapered tip 204 refers to the portion of support member 114 that begins below notch 122 and at nub 208, and extends to the distal end of support member 114. In response to nub 208 passing through hole 128, support member 114 may return to its original form or a less contorted form than when passing through hole 128, causing tapered tip 204 to move in the direction of arrow 210, thereby snapping support member 114 onto circuit board 106.

In some embodiments, depending on, e.g., the thickness of the circuit board relative to the size of notch 122, tapered tip 204 may be moved (manually or otherwise) in the direction of arrow 210 to unlock support member 114 from circuit board 106. If, while unlocked, a force is applied in a direction opposite to that of arrow 202, support member 114 can be removed or otherwise detached from circuit board 106.

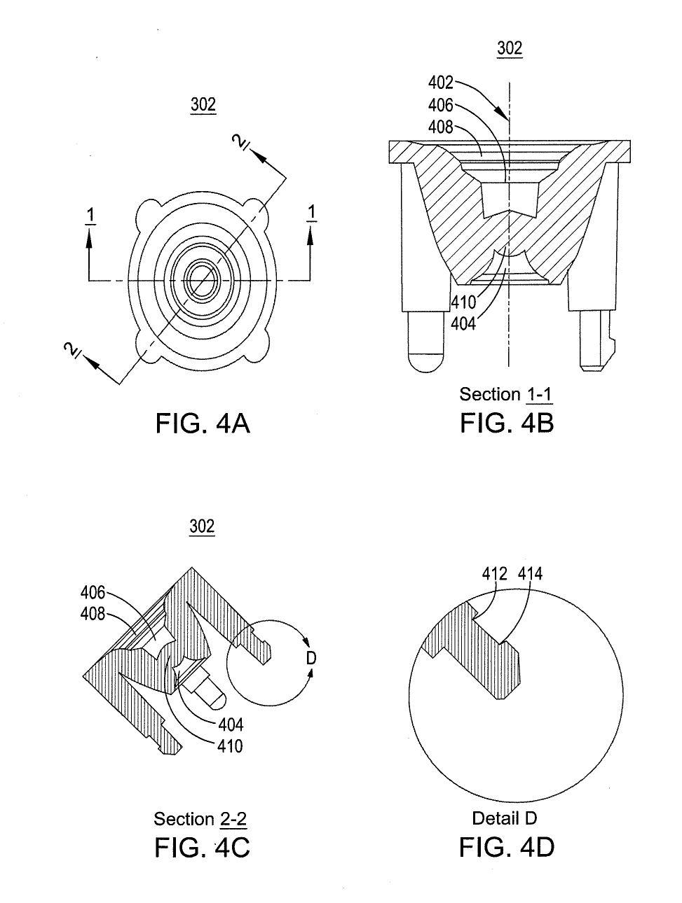

Notch 122 and tip 204 are shown in FIGS. 1, 2A, and 2B as being formed in the outer portion of the mounting post, such that notch 122 faces away from an imaginary axis that runs orthogonal to the circuit board, parallel to the support members and through the center of the optical lens. An example of an imaginary axis, imaginary axis 402, is shown in FIG. 4B. In this regard, arrow 206 points to the imaginary axis. By facing notch 122 away from the imaginary axis, notch 122 can be adapted to cause the mounting post to exert an outwardly force against interior wall 212 of hole 128, wherein the outwardly force is relative to the imaginary axis (i.e., in the direction of arrow 210).

This arrangement of notch 122 can help facilitate a relatively strong physical attachment between optical apparatus 102 and circuit board 106 without over stressing and/or causing damage to any portion of light emitting system 100. Additionally, by configuring notch 122 such that it faces away from the imaginary axis (as opposed to towards the imaginary axis) valuable space on the circuit board can be saved as compared to other approaches that could be used to physically attach optical apparatus 102 to circuit board 106. For example, space can be saved by locking each of the mounting posts to the circuit board using compression to exert an outwardly directed force (resulting in the posts having a slightly contorted shape) as compared to using hyper-extension to exert an inward force (towards the imaginary axis resulting in a slightly larger footprint on the circuit board).

Tip 204 is shown in the drawings as being tapered to assist with snapping optical apparatus 102 onto circuit board 106. In FIG. 2B, for example, tip 204 comprises conical portion 214 closest to the distal end of support member 114, and ramped portion 216 between conical portion 214 and nub 208. The combination and arrangement of conical portion 214 and ramp portion 216 can help facilitate quick snapping onto circuit board 106. In some embodiments, conical portion 214 and nub 208 can comprise different types of material. For example, conical portion 214 may be metal (e.g., a metal tip to protect the tip) while ramp portion 216 may comprise plastic and/or the same material as the rest of the mounting post. In other embodiments, both the conical portion 214 and ramp portion 216 can comprise the same material.

Additionally, tip 204 also comprises a non-pointed tip, namely flat end 218, at the distal end of support member 114. In other embodiments (some examples of which are discussed herein), another type of non-pointed tip (e.g., rounded tip) or a pointed tip may be included at the distal end of tapered tip 204.

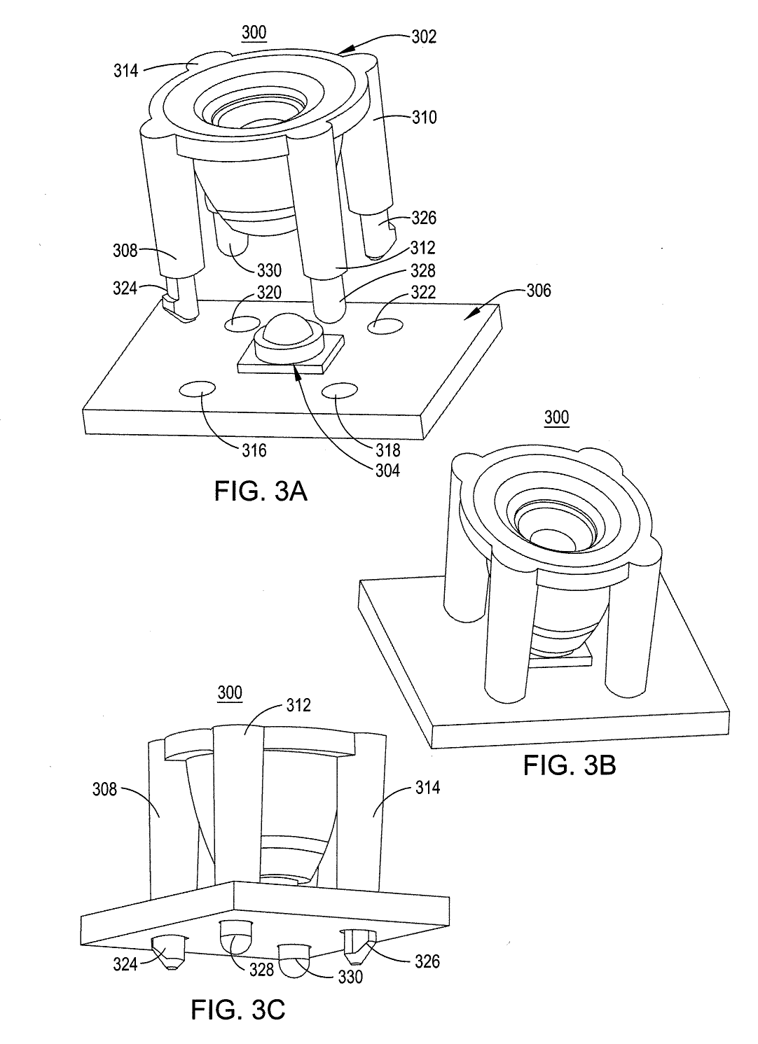

FIGS. 3A-3C show various views of light emitting system 300, which is another example in accordance with some embodiments. In many respects, light emitting system 300 is substantially similar to or the same as lighting system 100 discussed above. However, lighting system 300 is shown as including optical apparatus 302, which includes four support members, namely, mounting post 308, mounting post 310, alignment post 312 and alignment post 314 (as opposed to the three mounting post support members included in apparatus 102 discussed above). As exemplified, the optical apparatus can include different numbers of support members in various embodiments. Another difference between light emitting system 300 and light emitting system 100 is that circuit board 306 is configured with four holes, namely holes 316, 318, 320 and 322, configured to receive each supporting member of optical apparatus 302.

But unlike the support members of light emitting system 100, only mounting posts 308 and 310 include attaching components, namely attaching components 324 and 326. Attaching components 324 and 326 can be configured to, e.g., snap onto or otherwise physically attach to circuit board 306. Alignment posts 312 and 314 include alignment tips 328 and 330, respectively. Alignment tips 312 and 314 are configured to pass through holes 318 and 320, respectively, without physically attaching to circuit board 306. FIG. 3C shows an example of how alignment tips 328 and 330 pass through circuit board 306, while attaching components 324 and 326 attach optical apparatus 302 to circuit board 306. In this regard, alignment tips 328 and 330 can be used to properly align and maintain the alignment of optical apparatus 302 relative to LED package 304 and/or circuit board 306. Alignment tips 328 and 330 are also examples of rounded tips that may be included at the distal end of support members, regardless of whether the support member includes or lacks an attaching mechanism.

Additionally, like optical apparatus 102 discussed above, each of the support members of optical apparatus 302 can include a portion that is larger than its corresponding hole in circuit board 306. The portion of support member that contacts circuit board 306 is sometimes referred to herein as a “contact face” of the respective support member (which is discussed further in connection with, e.g., FIG. 4D). The contact face of alignment posts 312 and 314 can contact the circuit board while attaching components 324 and 326 are snapped onto the circuit board.

FIGS. 4A-4D show additional views of optical apparatus 302. FIG. 4A shows a top view of optical apparatus 302 and relative perspectives are presented in FIGS. 4B and 4C.

FIG. 4B also shows imaginary axis 402 discussed above, which runs orthogonal to the circuit board, parallel to the support members and through the center of the optical lens. In the top view of optical apparatus 302 shown in FIG. 4A, imaginary axis 402 is a point in the center of optical apparatus 302.

FIGS. 4B and 4C show cavity 404 configured to receive an LED package. In some embodiments, cavity 404 can include partitions or other structural components and/or shapes to receive multiple LED packages and/or other types of light emitting components. In some embodiments, the interior surface(s) of cavity 406 can be shaped to at least substantially mimic contours of the one or more LED packages.

A second cavity 406 can also be included below lens 408. Portion 410 between cavities 404 and 406 can include any type of material, including translucent material, opaque material, material that filters one or more particular wavelengths of light, colored material, any other material, or a combination thereof.

One skilled in the art would appreciate that cavity 404, cavity 406 and/or any other component discussed herein can be any shape and/or size. Additionally, in some embodiments (not shown), cavities 404 and 406 can join within portion 410, and/or form at least one hole which passes through portion 410 and lens 408. In other embodiments (not shown), cavities 404 and 406 can join within portion 410 and form a single larger cavity that extends to lens 408.

FIG. 4D shows a detailed insert of one of the attaching components of optical apparatus 302. The space between contact face 412 and nub 414, sometimes referred to herein as the “notch space,” can be configured to accommodate the thickness of circuit board 306 and/or anything else (including, e.g., layers or anything affixed to circuit board 306). In some embodiments, the notch space can be purposefully configured to be larger than the thickest circuit board to which optical element 302 is configured to attach.

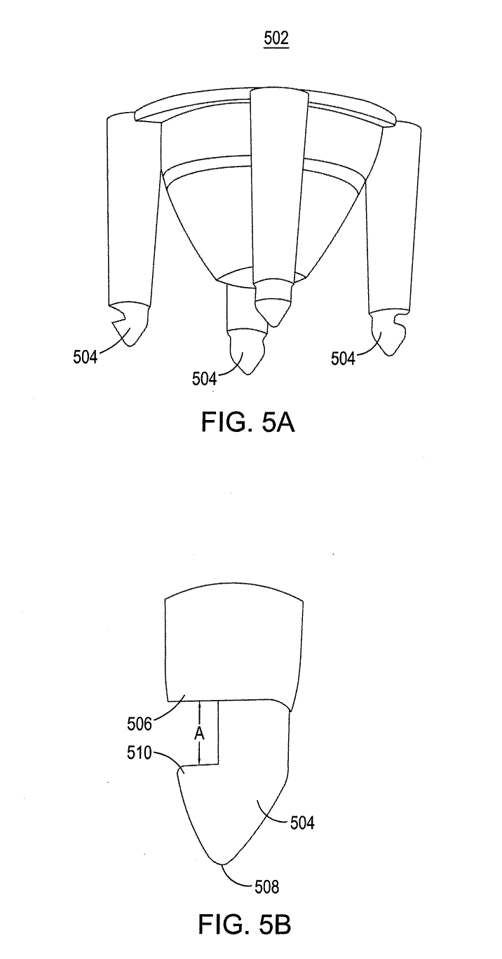

FIG. 5A shows an example optical element, namely optical apparatus 502, which includes four mounting posts that each include a tip 504 with a pointed end. FIG. 5B shows how the notch space below contact face 506 can be determined absent a well defined nub (such as nub 208 or nub 214 discussed above). A well defined nub may be omitted in some embodiments, such as those the same as or similar to that shown in FIG. 5B. FIG. 5B shows tip 504 as being conical from distal end 508 to the beginning of notch 510.

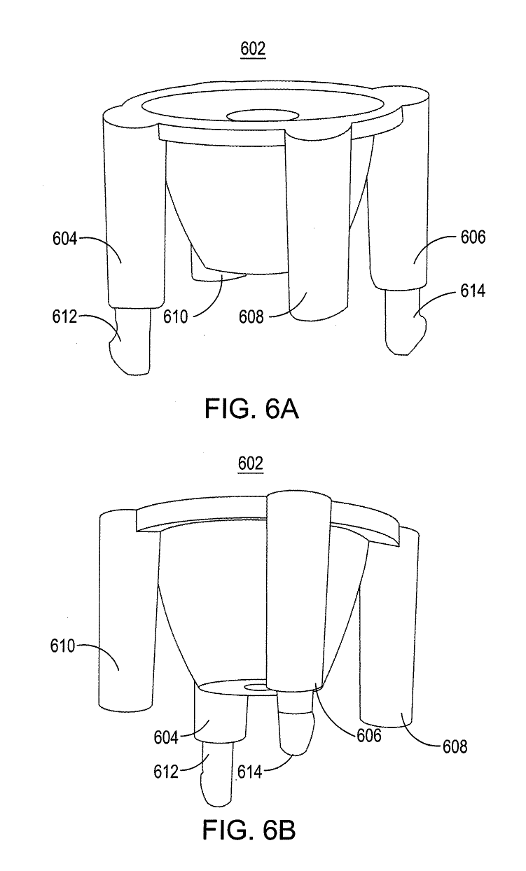

FIG. 6 shows optical apparatus 602, which is another example in accordance with some embodiments. Optical apparatus 602 includes four support members, including mounting post 604, mounting post 606, support post 608 and support post 610. Mounting posts 604 and 606 include attaching mechanisms 612 and 614, respectively. Support posts 608 and 610 lack any attaching mechanism or alignment mechanism and can be configured to contact or end above a circuit board or other component onto which optical apparatus 602 is mounted. For example, support posts 608 and 610 can include contact faces that contact and rest upon or exert pressure upon the top face of a circuit board while 604 and 606 are attached, e.g., snapped, to a circuit board, thereby stabilizing and/or otherwise supporting optical apparatus 602 should any downward forces be applied. Fewer holes in the circuit board may be beneficial in some embodiments by, for example, simplifying circuit board manufacturing and/or increasing circuit board strength and rigidity.

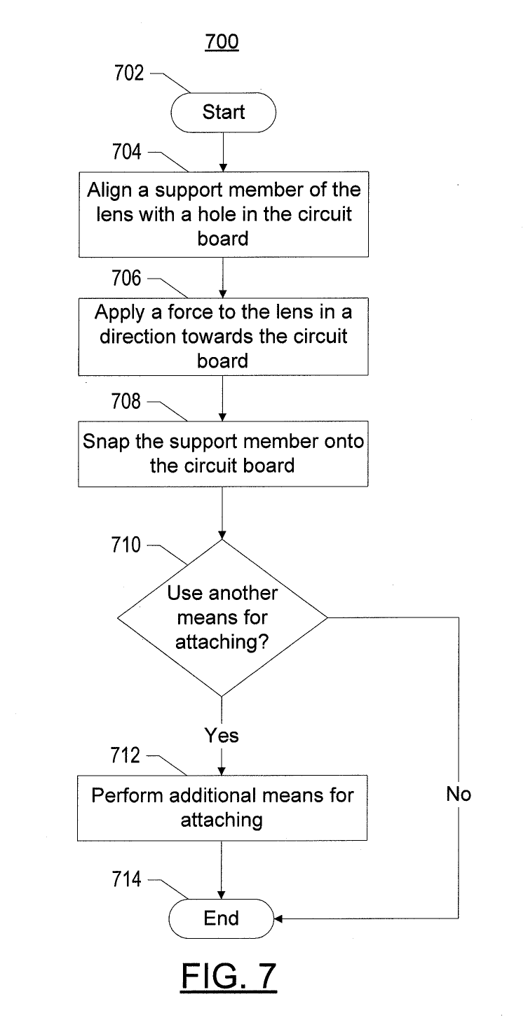

According to some exemplary aspects of embodiments, a processor may operate under control of a computer program product and be used to control the manufacturing equipment that can be used to, for example, assemble light emitting systems and/or optical apparatuses in accordance with some embodiments. For example, FIG. 7 shows process 700 that may be at least partially executed by a processor and/or other hardware that controls manufacturing equipment and/or other types of machines. The computer program product can include one or more application programs and/or other software used to control the operation of the manufacturing equipment. The computer program product can be implemented on a computer-readable storage medium, such as non-transitory, non-volatile storage medium.

As will be appreciated, the computer program product may be loaded onto a computer or other programmable apparatus to produce a machine, such that the instructions which execute on the computer or other programmable apparatus create means for implementing the functions described herein. These computer program instructions may also be stored in a computer-readable memory that may direct a computer or other programmable apparatus to function in a particular manner, such that the instructions stored in the computer-readable memory produce an article of manufacture, such as the optical apparatuses or lighting systems discussed above. The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions described herein.

For example, process 700 of FIG. 7 shows a method for affixing a lens to a circuit board. Process 700 starts at 702. Next, at 704, one or more support members of the optical apparatus are aligned with one or more corresponding holes in the circuit board. The optical apparatus can be aligned visually or otherwise (e.g., based on preconfigured movements in predetermined directions and distances).

At 706, a force is applied to the lens in a direction towards the circuit board. Further to the above discussion, the amount of force applied can correspond with, for example, the material(s) of each support member, the dimensions of each support member, the dimensions of the circuit board, among other things. The amount of force applied is preferably sufficient to cause the support member(s) to temporarily bend inwardly (or outwardly) without causing permanent damage.

As a result of the force being applied, at least one of the support members can snap onto the circuit board. For example, a notched attaching mechanism incorporated in the one or more support members can snap onto the circuit board, thereby physically attaching the optical apparatus to the circuit board. In some embodiments, applying the force to the optical apparatus can also causes a second support member to enter a second hole without snapping onto the circuit board. For example, the second support member can be an alignment post.

At 710, a determination is made as to whether an additional means for attaching should be implemented. Using multiple means of attaching can strengthen the bond created between the circuit board and the optical apparatus. For example, in response to determining at 710 that an adhesive tape or glue should be applied to the attaching component and/or alignment tip of the alignment post, the adhesive material can be applied at 712 to further secure the support member to the circuit board. As another example, in response to determining at 710 that melting a portion of the support member to the circuit board is required, the tip of the support member can be melted at 712 and allowed to solidify to further secure the support member to the circuit board.

In response to determining that no other means for attaching should be implemented or subsequent to completing 712, process 700 ends at 714.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A optical apparatus, comprising:
an optical lens; and
at least three support members, wherein at least one of the support members is a mounting post, the mounting post comprising:
a tip that is located at a distal end of the mounting post, wherein the tip is configured to guide the distal end of mounting post into a hole in a circuit board; and
a notch defined between the tip and the optical lens, wherein the notch is configured to physically attach the optical apparatus to the circuit board.

2. The optical apparatus of claim 1, wherein the notch is defined in the outer portion of the mounting post, such that the notch faces away from an imaginary axis running orthogonal to the circuit board, parallel to the support members and through a center of the optical lens.

3. The optical apparatus of claim 1, wherein the notch is configured to snap into the hole in the circuit board.

4. The optical apparatus of claim 1, wherein at least a portion of the mounting post is configured to prevent protrusion through the hole in the circuit board, wherein the portion is located between the notch and the optical lens.

5. The optical apparatus of claim 4, wherein the portion is cylindrical and has a diameter larger than that of the hole in the circuit board.

6. The optical apparatus of claim 1 further comprising a receptacle configured to receive a lighting emitting component.

7. The optical apparatus of claim 6, wherein the receptacle includes an interior surface that is shaped to at least substantially mimic contours of the light emitting component.

8. The optical apparatus of claim 1 further comprising a receptacle configured to receive at least two lighting emitting components.

9. The optical apparatus of claim 1, wherein the tip culminates in a pointed tip.

10. The optical apparatus of claim 1, wherein the tip culminates in a non-pointed tip.

11. The optical apparatus of claim 1, wherein the at least three support members include an alignment post that lacks a notch and is configured to contact a face of the circuit board.

12. The optical apparatus of claim 11, wherein the alignment post includes an alignment tip configured to enter a second hole in the circuit board without attaching the support post to the circuit board.

13. A optical apparatus, comprising:
an optical lens;
a first support member including:
a first tip, wherein the first tip is configured to guide the first support member into a first hole in the circuit board; and
a notch defined between the first tip and the optical lens, wherein the notch is defined in the outer portion of the mounting post, such that the notch faces away from an imaginary axis running orthogonal to the circuit board, parallel to the support members and through a center of the optical lens; and
a second support member including a second tip, wherein the second tip is configured to enter a second hole in the circuit board.

13. The optical apparatus of claim 13, wherein the second support member defines a second notch located between the second tip and the optical lens.

14. The optical apparatus of claim 13, wherein the second tip is tapered.

15. The optical apparatus of claim 13, wherein the second tip comprises an alignment tip that enters the second hole without physically attaching the optical apparatus to the circuit board.

16. The optical apparatus of claim 13 further comprising a third support member including:
a third tip, wherein the third tip is configured to guide the first support member into a first hole in the circuit board; and
another notch defined between the third tip and the optical lens, wherein the other notch is defined in the outer portion of the mounting post, such that the other notch faces away from the imaginary axis.

17. The optical apparatus of claim 13 further comprising a third support member including a third tip, wherein the third tip is configured to contact the circuit board without passing through a hole in the circuit board.

18. A method for affixing an optical apparatus to a circuit board, comprising:
aligning a support member of the optical apparatus with a hole in the circuit board; and
applying a force to the optical apparatus in a direction towards the circuit board, wherein applying the force is sufficient to cause the support member to bend inwardly while the force is being applied; and
snapping, as a result of applying the force, the support member onto the circuit board.

19. The method of claim 18 further comprising
aligning a second support member of the optical apparatus with a second hole in the circuit board, and
wherein applying the force to the optical apparatus causes the second support member to enter the second hole without snapping onto the circuit board.

20. The method of claim 18 further comprising applying an additional attachment means to further secure the support member to the circuit board.
